(19) United States
(12) Patent Application Publication
(10) Pub. No.: US 2025/0170663 A1
(43) Pub. Date: May 29, 2025

(54) METHOD FOR MANUFACTURING GEARINGS WITH A DEFINED ANGULAR POSITION

(71) Applicant: Klingelnberg AG, Zürich (CH)

(72) Inventor: Christian Brieden, Hückeswagen (DE)

(21) Appl. No.: 18/956,638

(22) Filed: Nov. 22, 2024

(30) Foreign Application Priority Data
Nov. 23, 2023 (EP) 23211869.5

(51) Int. Cl. B23F 5/16; B23F 19/12; B23F 23/12

(52) U.S. Cl. CPC B23F 5/163; B23F 19/12; B23F 23/1218

(57) ABSTRACT

A hard finishing of a component, wherein the component has a first gearing and a second gearing, wherein a nominal angular position of the second gearing relative to the first gearing is defined for the component. The identification of a reference for achieving the nominal angular position is carried out by a pattern matching of measured actual angular distances to predetermined nominal angular distances.

### CROSS-REFERENCE TO RELATED APPLICATIONS

This application claims the benefit of European patent application 23211869.5 filed 23 Nov. 2023, the disclosure of which is incorporated herein by reference in its entirety.

### TECHNICAL FIELD

The present disclosure relates to a method comprising the method steps of: providing a component, wherein the component has a first gearing and a second gearing, wherein a nominal angular position of the second gearing relative to the first gearing is defined for the component, and wherein the nominal angular position is specified as the nominal angular distance of a reference tooth and/or a reference gap of the first gearing to a tooth and/or a gap of the second gearing; identifying the reference tooth and/or the reference gap of the first gearing; hard finishing the second gearing of the component, wherein the teeth of the second gearing are machined taking into account the position of the reference tooth and/or the reference gap of the first gearing in order to produce an actual angular position of the second gearing relative to the first gearing corresponding to the predetermined nominal angular position.

### BACKGROUND

Compact gearboxes are used in electromobility to ensure that the electric drivetrain operates as efficiently as possible. The gearbox makes it possible to operate an electric motor in a low-consumption speed range.

For gear shafts that have two fixed gears, for example, a relative angular position is often defined between the teeth of the fixed gears, e.g. to enable reliable assembly.

Every relative positional relationship between two objects requires a geometric reference against which the relative position of these objects to each other is defined. In the state of the art, this reference is defined for the two gearings, for example, as a tooth of one of the two gearings. Such a tooth can be referred to as a reference tooth. With respect to this reference tooth of one gearing, an angular position of a tooth of the respective other gearing is dimensioned and toleranced.

If the component is reclamped after fine machining of the first gearing and before fine machining of the second gearing, the relevant reference tooth must be identified after the component has been reclamped and before fine machining of the second gearing begins. This is because only then can the fine machining of the second tooth be carried out in such a way that the required tolerances for the relative position of the second tooth to the reference tooth are maintained.

To identify the reference tooth, it is known in the prior art that the reference tooth or the component has a marking by means of which the reference tooth can be recognized. The marking can be, for example, a hole in an area of the component adjacent to the gearing or, for example, a marking of a tooth head of the reference tooth itself, e.g. in the form of a colored marking, an indentation, an adhesively applied marking or the like.

Generating the marking represents an additional, unproductive manufacturing step that increases the overall machining time. In addition, the gear cutting machine in question, which fine-machines the first gear, must be assigned a device for generating the marking, which must be specially designed and provided for this purpose.

Furthermore, the use of such a marking is disadvantageous in that a gear cutting machine used to manufacture the second gearing must have a device for detecting such a marking, which may be provided specifically for this purpose in addition to any measuring or processing means of the gear cutting machine.

### SUMMARY

The present disclosure is therefore based on the technical problem of providing an efficient method for manufacturing a component which has two gearings with a predetermined relative angular position.

The technical problem described above is solved with the features of the independent claim. Further designs of the disclosure result from the dependent claims and the following description.

According to the disclosure, a method is provided, having the method steps of: providing a component, wherein the component has a first gearing and a second gearing, wherein a nominal angular position of the second gearing relative to the first gearing is defined for the component, and wherein the nominal angular position is specified as the nominal angular distance of a reference tooth and/or a reference gap of the first gearing from a tooth and/or a gap of the second gearing; identifying the reference tooth and/or the reference gap of the first gearing; hard finishing the second gearing of the component, wherein the teeth of the second gearing are machined taking into account the position of the reference tooth and/or the reference gap of the first gearing in order to produce an actual angular position of the second gearing relative to the first gearing corresponding to the predetermined nominal angular position. The method is characterized in that the identification of the reference tooth and/or the reference gap of the first gearing is carried out by assigning measured actual angular distances to predetermined nominal angular distances, wherein the nominal angular distances are predetermined angular distances of the teeth and/or gaps of the first gearing relative to the teeth and/or gaps of the second gearing corresponding to the predetermined nominal angular position and wherein the measured actual angular distances are the angular distances of the teeth and/or gaps of the first gearing relative to the teeth and/or gaps of the second gearing existing on the provided component before the hard finishing of the second gearing.

The disclosure is basically based on the idea of using an arrangement, in particular a resulting pattern, of the relative distances of the teeth and/or gaps of the two gearings resulting from the predetermined component design in order to clearly identify individual teeth and/or gaps, i.e. in particular the reference tooth and/or the reference gap. This is because the angular distances specified by the component design should already be recognizable on the component, in particular after pre-gearing of the first and second gearing and after fine machining of the first gearing, before fine machining of the second gearing. In particular, by comparing an expected arrangement or an expected pattern of the angular positions from the component design with an arrangement or pattern measured on the component, the manufactured teeth and/or gaps can be assigned to the teeth and/or gaps according to the design in order to find the dimensioned and toleranced angular distance of the reference, i.e. to identify the reference tooth and/or the reference gap.

In other words, the reference tooth and/or the reference gap can therefore be identified according to the disclosure in particular by comparing a characteristic pattern of nominal angular distances with measured actual angular distances. Thus, according to the disclosure, a separate marking for identifying the reference tooth and/or the reference gap can be dispensed with. Both the generation and the detection of the marking and also the operating means required for this can therefore be dispensed with compared to the prior art. The method according to the disclosure for identifying a reference tooth and/or a reference gap is therefore faster and more cost-effective overall compared to the prior art.

Thus, an efficient method for manufacturing a component is specified, which has two gearings with a predetermined relative angular position.

The first gearing can be designed as one of the following types of gearing: spur gearing, helical gearing, herringbone gearing, double helical gearing, beveloid gearing.

The second gearing can be designed as one of the following types of gearing: spur gearing, helical gearing, herringbone gearing, double helical gearing, beveloid gearing.

The first gearing can be an external gearing or an internal gearing.

The second gearing can be an external gearing or an internal gearing.

The first gearing can be a running gearing. The first gearing can be set up to convert speeds and torques with an associated further gearing that meshes with the first gearing by means of rotary transmission in rolling contact—in particular within a gearbox.

The second gearing can be a running gearing. The second gearing can be set up to convert speeds and torques with an associated further gearing that meshes with the first gearing by means of rotary transmission in rolling contact—in particular within a gearbox.

The nominal angular distance can be related to an axis of rotation of the component. In particular, the nominal angular distance can, for example, be defined in an axial projection in a plane perpendicular to the axis of rotation around the axis of rotation and can be measured as the actual angular distance on the component.

The nominal angular distance can be defined in relation to a respective flank center of the relevant teeth of the first gearing and/or the second gearing—e.g. for the nearest right-hand flanks and/or nearest left-hand flanks.

The nominal angular distance can be defined on a flank point of a respective tooth on the respective pitch circle of the first gearing and the second gearing.

It is understood that a tooth gap can also be used as a reference, wherein an actual position of a gap in question results in turn from the actual position of the manufactured flanks. It is therefore irrelevant for the success of the method whether a gap or a tooth is used as a reference.

If a reference of the angular position is defined on the basis of a gap of the first gearing relative to a gap of the second gearing, this can be referred to as a reference gap pair.

If a reference of the angular position is defined using a tooth of the first gearing relative to a tooth of the second gearing, this can be referred to as a reference tooth pair.

The reference of the angular position can be defined using a tooth of the first gearing relative to a gap of the second gearing.

The reference of the angular position can be defined using a gap of the first gearing relative to a tooth of the second gearing.

In particular, exactly one tooth of the first gearing is defined as the reference tooth or, in particular, exactly one gap of the first gearing is defined as the reference gap. With respect to this reference tooth or with respect to this reference gap of the first gearing, the nominal angular distance of a gap or a tooth of the second gearing is dimensioned and toleranced in order to define the nominal angular position.

This tooth or this gap of the second gearing can be a tooth of the second gearing or a gap of the second gearing that is closest to the reference tooth or to the reference gap of the first gearing, or can be any other tooth of the second gearing or any other gap of the second gearing. This is because by defining the nominal angular distance of a tooth or a gap of the second gearing in relation to the reference tooth or the reference gap of the first gearing, the relative angular position of all other teeth and gaps of the second gearing to the reference tooth of the first gearing and to all other teeth and gaps of the first gearing is also defined due to the inherent symmetry of the respective first and second gearing designed as running gearing.

According to one design of the method, it may be provided that the nominal angular distances of the teeth and/or gaps, in particular of the nearest teeth and/or gaps, are specified sorted consecutively in a clockwise or counterclockwise order so as to specify a nominal pattern of the nominal angular distances and the actual angular distances of the nearest teeth are specified sorted consecutively in a clockwise or counterclockwise order so as to specify an actual pattern of the actual angular distances, wherein the identification of the reference tooth and/or the reference gap is carried out by means of a matching of the actual pattern with the nominal pattern.

It may be provided that the nominal pattern is determined and/or evaluated for a selection of adjacent or nearest teeth or for all adjacent or nearest teeth. It may be provided that the actual pattern is determined and/or evaluated for a selection of adjacent or nearest teeth or for all adjacent or nearest teeth. Depending on the number of teeth of the first and second gearing, even a partial match may be sufficient to identify the reference tooth. A complete match is preferred.

The actual pattern can be matched with the nominal pattern using a mathematical method, such as best-fit or the like, in particular software-based. This means that the measured actual pattern is placed over the specified nominal pattern in such a way that the deviations between the actual pattern and the nominal pattern are as small as possible or minimized. In this way, a tooth-by-tooth assignment of the teeth of the measured actual pattern to the teeth of the nominal pattern can be carried out or a gap-by-gap assignment of the gaps of the measured actual pattern to the gaps of the nominal pattern can be carried out in order to determine the reference tooth and/or the reference gap of the first gearing.

According to one design of the method, it may be provided that, as a result of the assignment of the nominal angular distances to measured actual angular distances, the reference tooth is that tooth of the first gearing of the component whose actual angular distance corresponds to the nominal angular distance corresponding to the specified nominal angular position, wherein in particular a matching of the nominal angular distance to the actual angular distance is carried out for one or more further teeth and/or gaps of the first gearing in order to verify the identification of the reference tooth.

According to one design of the method, it may be provided that, as a result of the assignment of the nominal angular distances to measured actual angular distances, the reference gap is that gap of the first gearing of the component whose actual angular distance corresponds to the nominal angular distance corresponding to the specified nominal angular position, wherein in particular a matching of the nominal angular distance to the actual angular distance is carried out for one or more further teeth and/or gaps of the first gearing in order to verify the identification of the reference gap.

It may be provided that the first gearing of the provided component has already been hard-finished before the hard finishing of the second gearing and before the identification of the reference tooth and/or the reference gap.

After hard finishing of the first gearing and before hard finishing of the second gearing, the component may be reclamped.

According to one design of the method, it may be provided that the hard finishing of the first gearing takes place on a first machine tool and the hard finishing of the second gearing takes place on a second machine tool. Accordingly, the component can be removed from a workpiece spindle of the first machine tool after the fine machining of the first gearing and then clamped on a workpiece spindle of the second machine tool in order to fine-machine the second gearing using the second machine tool. The reference tooth and/or the reference gap of the first gearing is identified before the second gearing is fine-machined using the second machine tool.

The hard finishing of the first gearing can be scraping or hard skiving or honing. Accordingly, the first gearing can be machined in particular using a process that requires only a small axial overrun and can therefore be used close to collision structures, such as in the vicinity of the second gearing adjacent to the first gearing.

In particular, the first gearing can have a smaller diameter than the second gearing. According to alternative designs, it may be provided that the first gearing has a larger diameter than the second gearing.

The first gearing can have a small axial distance to the second gearing, wherein the axial distance is in particular less than a tooth width of the first gearing and/or a tooth width of the second gearing, in particular less than half a tooth width of the first gearing and or half a tooth width of the second gearing.

The hard finishing of the second gearing can be grinding, in particular generating grinding. The second gearing can, for example, be machined using very efficient generating grinding, particularly in the event that the second gearing has a larger diameter than the first gearing and the first gearing therefore does not form a collision structure for machining the second gearing.

The first gearing can have a smaller number of teeth than the second gearing. According to alternative embodiments, it may be provided that the first gearing has a larger number of teeth than the second gearing.

The first gearing can have a smaller pitch diameter than the second gearing. According to alternative designs, it may be provided that the first gearing has a larger pitch diameter than the second gearing.

The number of teeth of the first gearing and the number of teeth of the second gearing can be mutually prime, wherein exactly one tooth and/or exactly one gap of the first gearing are defined as a reference tooth and/or as a reference gap.

The number of teeth of the first gearing and the number of teeth of the second gearing can have the same divisors, wherein a number of teeth suitable as reference teeth corresponds to the largest common divisor with respect to the number of teeth of the first gearing and the number of teeth of the second gearing, and wherein one of these teeth of the first gearing suitable as reference tooth is defined as reference tooth.

The number of teeth of the first gearing and the number of teeth of the second gearing can have the same divisors, wherein a number of gaps suitable as reference gaps corresponds to the largest common divisor with respect to the number of teeth of the first gearing and the number of teeth of the second gearing, and wherein one of these gaps of the first gearing suitable as a reference gap is defined as a reference gap.

The disclosure is explained in more detail below with reference to a drawing illustrating exemplary embodiments, which schematically show in each case:

### BRIEF DESCRIPTION OF THE DRAWINGS

FIG. 1 shows a component with a first gearing and with a second gearing in a perspective view;

FIG. 2 shows the component from FIG. 1 in a side view;

FIG. 3 shows the component from FIG. 1 in a front view;

FIG. 4 shows an enlarged view according to detail Z from FIG. 3;

FIG. 5 shows nominal angular positions of a first gearing with 23 teeth and a second gearing with 68 teeth;

FIG. 6 shows nominal angular positions of a first gearing with 23 teeth and a second gearing with 62 teeth;

FIG. 7 shows nominal angular positions of a first gearing with 23 teeth and a second gearing with 66 teeth;

FIG. 8 shows nominal angular positions of a first gearing with 23 teeth and a second gearing with 61 teeth;

FIG. 9 shows nominal angular positions of a first gearing with 24 teeth and a second gearing with 62 teeth;

FIG. 10 shows nominal angular positions of a first gearing with 24 teeth and a second gearing with 66 teeth;

FIG. 11 shows nominal angular positions of a first gearing with 24 teeth and a second gearing with 63 teeth;

FIG. 12 shows actual angular positions of a first gearing with 23 teeth and a second gearing with 68 teeth;

FIG. 13 shows an assignment of the actual angular positions from FIG. 12 to the nominal angular positions from FIG. 5;

FIG. 14 shows the assignment of the actual angular positions from FIG. 12 to the nominal angular positions from FIG. 5;

FIG. 15 shows an identification of a reference tooth based on the assignment of the actual angular positions from FIG. 12 to the nominal angular positions from FIG. 5; and

FIG. 16 shows a flow chart of a method according to the disclosure.

### DETAILED DESCRIPTION OF THE DRAWINGS

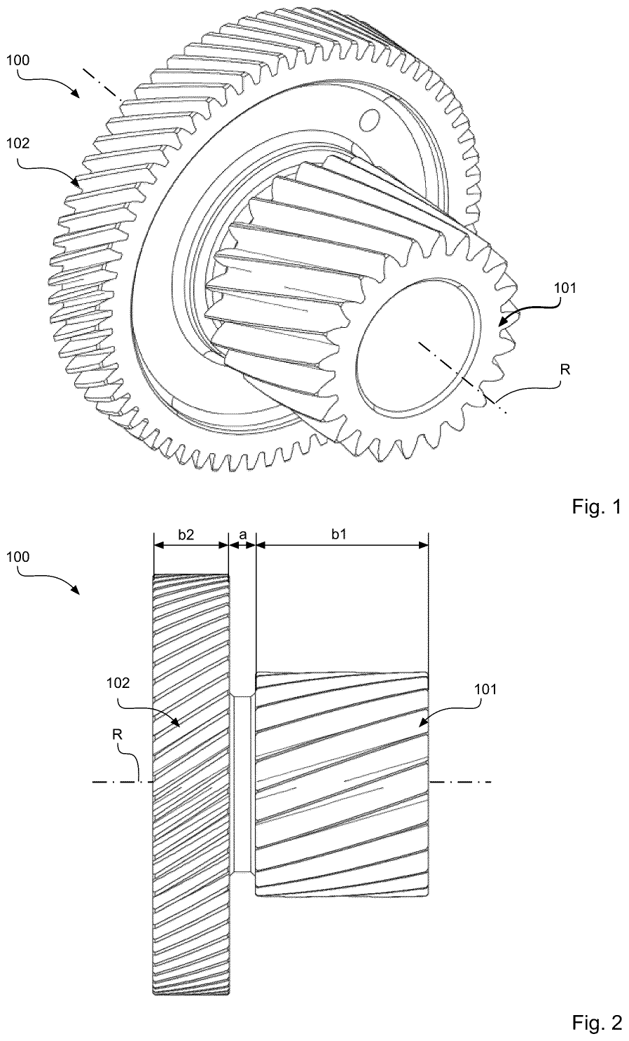

FIG. 1 shows a component 100. The component 100 has a first gearing 101 and a second gearing 102. The component 100 consists in particular of a hardened steel material.

The first gearing 101 has an axial distance a from the second gearing 102 that is less than a width b2 of the second gearing 102 and is equally less than a width b1 of the first gearing 101 (FIG. 2).

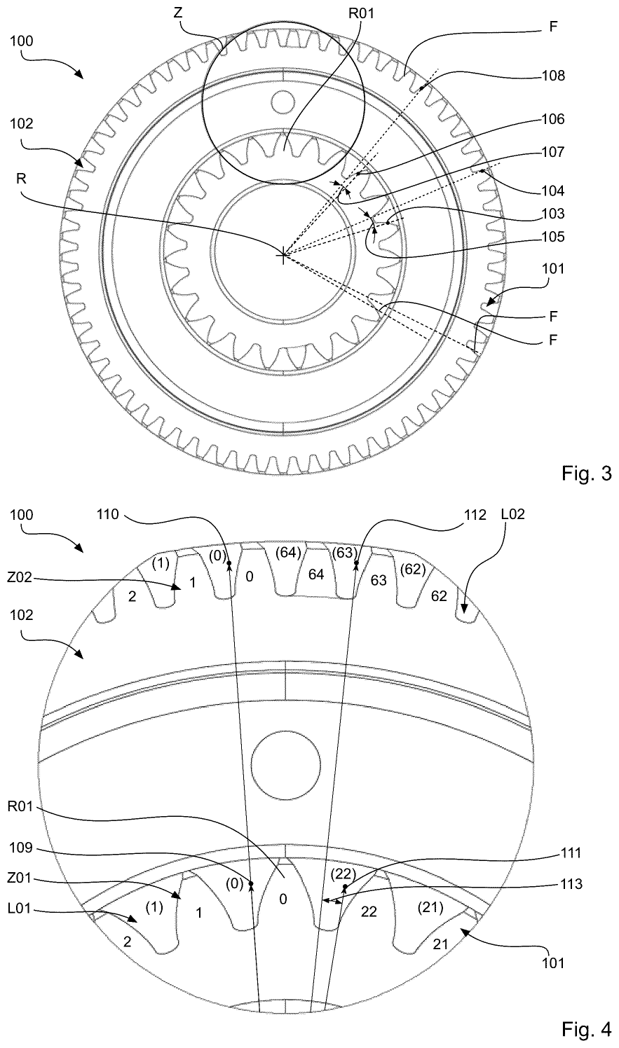

In order to define a relative angular position of the first gearing 101 to the second gearing 102, it is sufficient to define a nominal angular distance, e.g. for a reference tooth R01 of the first gearing 101 relative to a tooth of the second gearing 102 (FIG. 3). The relative angular position defines the overall angular position of the gearings 101, 102 in relation to an axis of rotation R of the component 100.

In the present example, the case is discussed in which the first gearing 101 is hard-finished first and then the second gearing 102 is hard-finished. Accordingly, the reference tooth R01 is formed on the first gearing 101, since an angular distance to a tooth of the second gearing 102 is dimensioned and toleranced with respect to this reference tooth R01 in order to be able to produce the relative nominal angular position as accurately as possible as the actual angular position during hard finishing of the second gearing 102.

It is understood that, according to an alternative exemplary embodiment, a tooth of the second gearing 102 can be determined as a reference tooth with respect to which the first gearing is aligned. This procedure would be particularly useful in the event that the second gearing is hard-finished before the first gearing, and thus an angular distance of a tooth of the first gearing 101 is dimensioned and toleranced with respect to a reference tooth of the second gearing in order to specify the relative angular position.

It is understood that gaps and/or teeth of the gear teeth could equally be used to define the relative angular position so that, for example, a tooth-to-tooth angular distance, a gap-to-gap angular distance, a gap-to-tooth angular distance or a tooth-to-gap angular distance can be specified to define the relative angular position of the first gearing to the second gearing, or vice versa. In principle, therefore, each of the gaps or teeth of the first gearing 101 and each of the gaps or teeth of the second gearing 102 can be used to dimension and tolerance the relative angular position between the first and second gearing in order to unambiguously define this relative angular position.

As already mentioned, a tooth of the first gearing is defined as reference tooth R01 in the present example. For example, it can be specified that the angular distance between a flank center 109 of the reference tooth R01 of the first gearing 101 to a flank center 110 of a tooth with the index 0 of the second gearing should be equal to 0. In this way, the nominal angular position of the first gearing 101 relative to the second gearing shown in FIGS. 1-4 is clearly described.

Alternatively, however, an angle 113 existing between a tooth with the index “22” of the first gearing 101 and a tooth with the index 63 of the second gearing 113 corresponding to the nominal angular position could also be dimensioned and toleranced for unambiguous definition of the nominal angular position, so that the tooth with the index “22” of the first gearing 101 could be defined as the reference tooth. In this way again, the nominal angular position of the first gearing 101 relative to the second gearing shown in FIGS. 1-4 would be clearly described.

FIGS. 1-4 show an example of a nominal geometry to be produced for the component 100, which is to be manufactured using the method according to the disclosure.

FIG. 4 shows an enlarged representation according to detail Z from FIG. 3. The teeth Z01 of the first gearing 101 are numbered in ascending order starting with index 0 counterclockwise up to index 22, so that the first gearing 101 in this example has 23 teeth and 23 gaps. The gaps are numbered accordingly with numbering or indices in brackets, also in ascending order from 022. Similarly, the teeth of the second gearing 102 are also numbered in an ascending counterclockwise sequence starting with the tooth with index 0 up to the tooth with index 64, so that the second gearing 102 in the present example has 65 teeth and 65 gaps. Furthermore, the gaps of the gearing 102 are also numbered counterclockwise in brackets from 0-64. In the present example, the left flank of the respective tooth with the number “0” of the first gearing 101 and of the second gearing 102 is to serve as a reference in each case, wherein the tooth with the number 0 of the first gearing 101 is the reference tooth R01 and the angular position of the tooth with the number 0 of the second 102 is dimensioned and toleranced with respect to this reference tooth R01.

As already mentioned at the beginning, a particular challenge is to automatically determine the reference tooth R01 between the individual production steps and after reclamping the component 100. For example, the first gearing 101 may have been hard-finished on a first machine tool and then transferred to another machine tool for hard-finishing of the second gearing. After this renewed clamping or during handling, the reference tooth R01 must be identified in order to enable the production of the relative angular position between the first gearing 101 and the second gearing 102 in accordance with the nominal angular position.

The identification of the reference tooth R01 is achieved according to the disclosure by assigning measured actual angular distances to predetermined nominal angular distances, wherein the nominal angular distances are predetermined angular distances of the teeth Z01 and/or gaps L01 of the first gearing 101 relative to the teeth Z02 and/or gaps L02 of the second gearing 102 corresponding to the predetermined nominal angular position.

The measured actual angular distances are the angular distances of the teeth Z01 and/or gaps L01 of the first gearing 101 relative to the teeth Z02 and/or gaps L02 of the second gearing 102 existing on the provided component 100 before the hard finishing of the second gearing 102.

The disclosure utilizes the fact that the predetermined nominal angular position results in a pattern of relative angular positions of adjacent teeth Z02 or nearest teeth Z02 and/or gaps L02 of the second gearing 102 to the teeth Z01 and/or gaps Z01 of the first gearing 101.

In FIG. 3, a nominal angular distance 105 between a flank point 103 on the pitch circle of the first gearing 101 and a flank point 104 on the pitch circle of the second gearing 102 is shown in an axial projection. Furthermore, a nominal angular distance 107 is shown between a flank point 106 on the pitch circle of the first gearing 101 and a further adjacent flank point 108 on the pitch circle of the second gearing 102. Starting from the first gearing 101, the adjacent or nearest flanks F are the flank F of the second gearing 102 following a flank F of the first gearing 101 when viewed counterclockwise around the axis of rotation R.

It can be seen that the angular distance 107 is smaller than the angular distance 105. In this way, a gap-to-gap angular distance or a tooth-to-tooth distance or a tooth-to-gap distance to the respective nearest tooth Z02 or to the nearest gap L02 of the second gearing 102 can be specified for each tooth or for each gap of the gearing 101.

For a component 100 having a first gearing 101 and a second gearing 102 with a predetermined relative angular position, the nominal angular distances of nearest teeth and/or gaps can be specified in a clockwise or counterclockwise order to indicate a nominal pattern of the nominal angular distances.

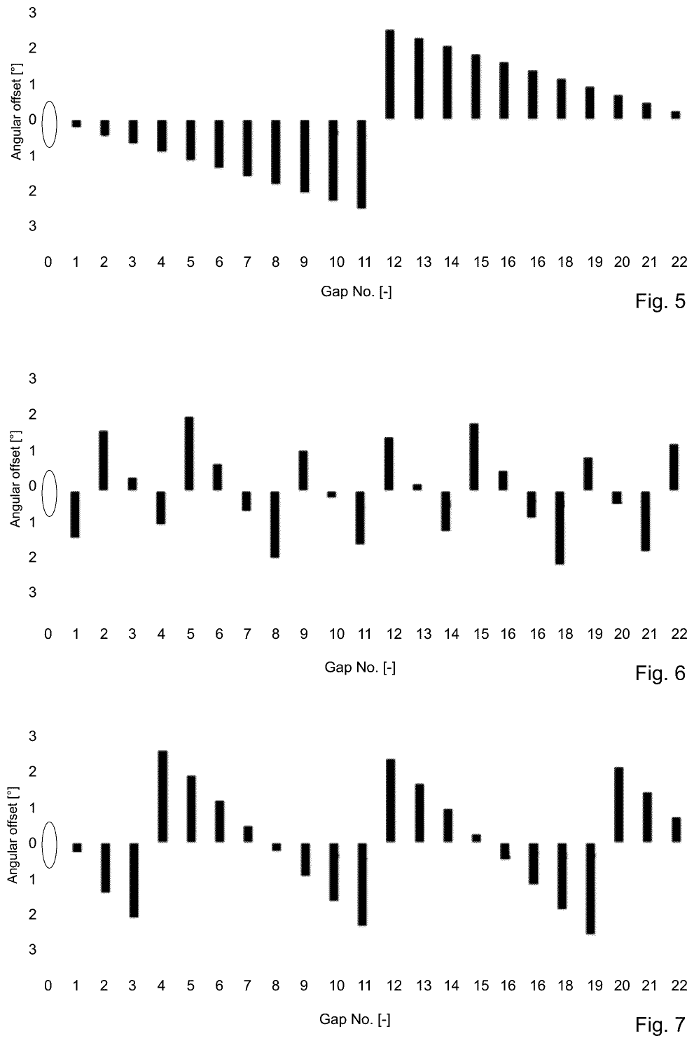

FIGS. 5-11 show such nominal patterns for different numbers of teeth of the first gearing 101 and the second gearing in order to illustrate the effect of the numbers of teeth on the resulting nominal patterns.

FIG. 5 shows an example of the angular distances or angular offset, wherein the first gearing 101 has 23 teeth and the second gearing 102 has 68 teeth. The angular distance between a gap in the first gearing and the nearest gap in the second gearing is plotted above the number of gaps in the first gearing 101. The numbering of the gaps is analogous to FIG. 4. The nominal angular position of the first gap of the first gearing 101 to the first gap of the second gearing 102 is equal to 0, wherein the first gap of the first gearing is the reference gap with respect to which the first gap of the second gearing is dimensioned and toleranced with an angular distance of 0. For the gap of the first gearing 101 with the index 0, the angular offset to the nearest gap of the second gearing 102 with the index 0 is therefore 0.

Since the number of teeth of the first gearing 101 and the second gearing are mutually prime, there is an individual angular offset for each gap of the first gearing 101 to the nearest gap of the second gearing. In other words, there is exactly one gap-to-gap angular offset, which is 0, namely for the reference gap of the first gearing 101 with the index 0.

If an actual pattern of the existing angular distances is now measured for a provided component after hard finishing of the first gearing 101 and before hard finishing of the second gearing 102, the reference gap of the first gearing 101 with index 0 can be identified by comparing it with the nominal pattern as shown in FIG. 5.

FIG. 12 shows a measured actual pattern as an example and schematically, wherein the actual angular distances of the nearest teeth are indicated in sequence according to the direction of rotation of the nominal pattern in order to indicate the actual pattern of the actual angular distances. The measured angular distance of a gap of the first gearing to the respective nearest gap of the second gearing is plotted over the number of gaps of the first gearing 101.

The indices of the gaps in the first gearing 101 have initially been replaced by question marks in FIG. 12, as it is not initially clear which gaps are to be assigned to the measured angular distances simply by looking at the actual pattern. For example, three angular distances with an amount close to 0 can be seen, each of which could belong to the reference gap, taking manufacturing tolerances into account.

The actual pattern is superimposed on the nominal pattern using software, e.g. “best fit”, in order to identify the gaps. Figuratively speaking, the actual pattern or the measured actual gearing is “rotated” relative to the nominal pattern or nominal gearing until the patterns match with as little deviation as possible.

The assignment of the actual pattern according to FIG. 12 to the nominal pattern is illustrated in FIG. 13. In this way, the reference gap with the index 0 can be clearly identified on the actual pattern to enable the centering for the hard finishing of the second gearing and the reliable production of the relative angular position of the gearings 101, 102.

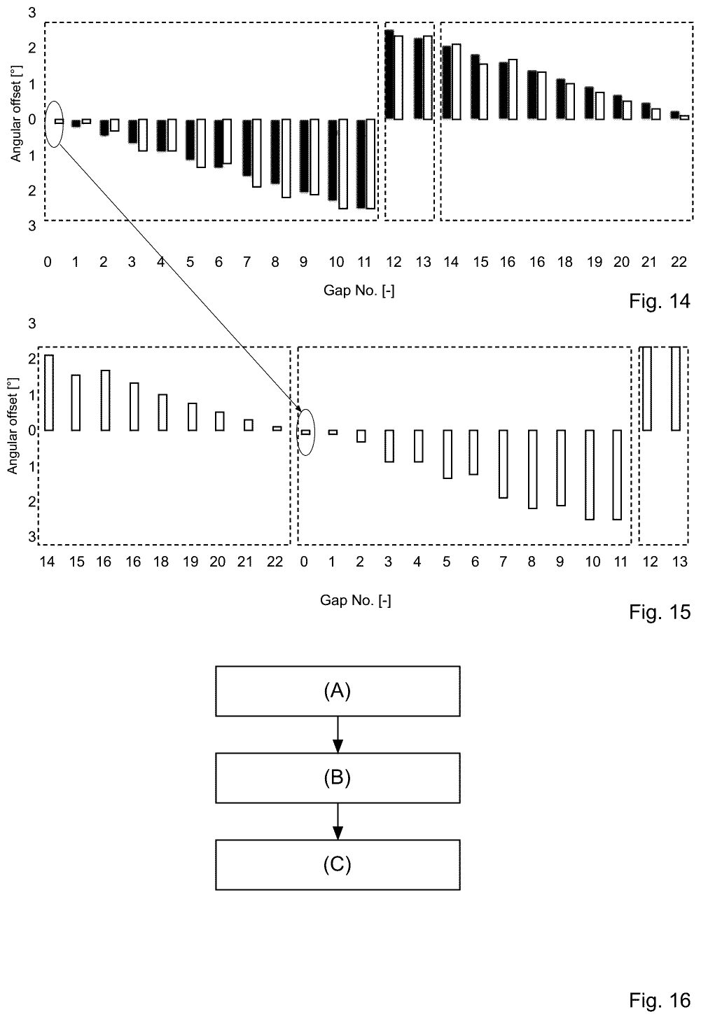

FIGS. 14 and 15 illustrate the complete match, wherein each gap of the first gearing 101 has been clearly identified on the measured actual pattern.

Since the overall position is a relative position between the first gearing 101 and the second gearing 102, it is irrelevant whether the nominal angular distance is measured relative to the second gearing 102 as viewed from the first gearing 101 or vice versa. Similarly, it is irrelevant whether a tooth flank, a position of a gap or a position of a tooth of the first gearing is used as a reference to define the angular position, since the relative positions of these references can be converted into each other and only a measurable reference must be present at the first gearing.

FIG. 6 shows an example of the angular distances or angular offset, wherein the first gearing 101 has 23 teeth and the second gearing 102 has 62 teeth. The angular distance between a gap in the first gearing and the nearest gap in the second gearing is plotted above the number of gaps in the first gearing 101. The numbering of the gaps is analogous to FIG. 4. The nominal angular position of the first gap of the first gearing 101 to the first gap of the second gearing 102 is equal to 0, wherein the first gap of the first gearing is the reference gap with respect to which the first gap of the second gearing is dimensioned and toleranced with an angular distance of 0. For the gap of the first gearing 101 with the index 0, the angular offset to the nearest gap of the second gearing 102 with the index 0 is therefore 0.

Since the number of teeth of the first gearing 101 and the second gearing are mutually prime, there is an individual angular offset for each gap of the first gearing 101 to the nearest gap of the second gearing. In other words, there is exactly one gap-to-gap angular offset, which is 0, namely for the reference gap of the first gearing 101 with the index 0.

FIG. 7 shows an example of the angular distances or angular offset, wherein the first gearing 101 has 23 teeth and the second gearing 102 has 66 teeth. The angular distance between a gap in the first gearing and the nearest gap in the second gearing is plotted above the number of gaps in the first gearing 101. The numbering of the gaps is analogous to FIG. 4. The nominal angular position of the first gap of the first gearing 101 to the first gap of the second gearing 102 is equal to 0, wherein the first gap of the first gearing is the reference gap with respect to which the first gap of the second gearing is dimensioned and toleranced with an angular distance of 0. For the gap of the first gearing 101 with the index 0, the angular offset to the nearest gap of the second gearing 102 with the index 0 is therefore 0.

Since the number of teeth of the first gearing 101 and the second gearing are mutually prime, there is an individual angular offset for each gap of the first gearing 101 to the nearest gap of the second gearing. In other words, there is exactly one gap-to-gap angular offset, which is 0, namely for the reference gap of the first gearing 101 with the index 0.

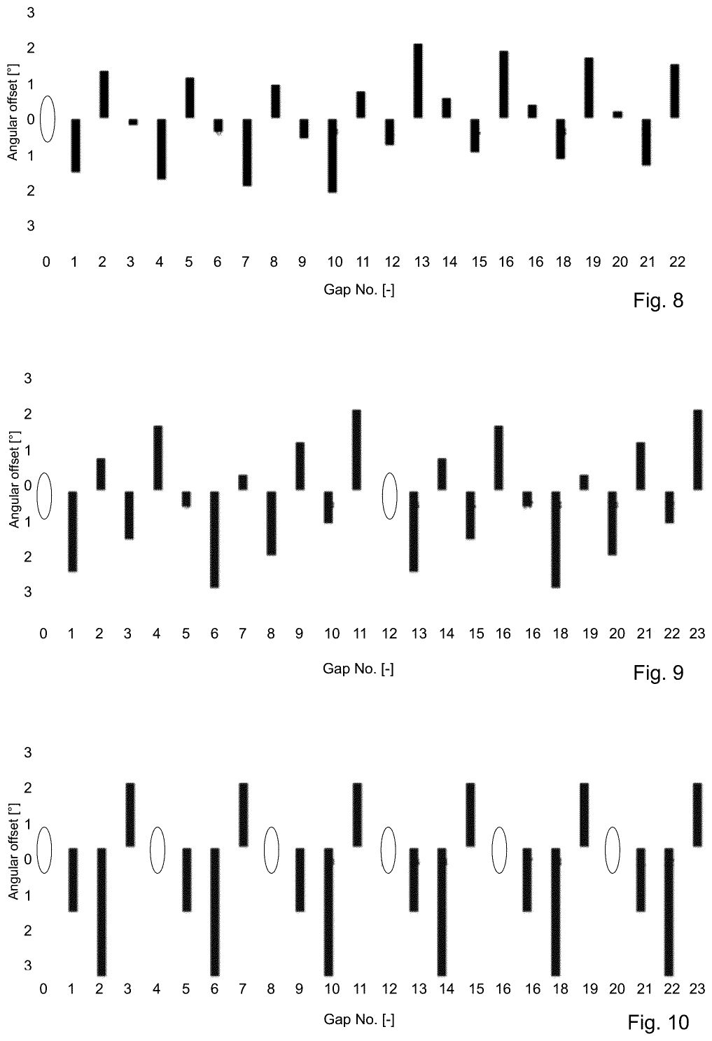

FIG. 8 shows an example of the angular distances or angular offset, wherein the first gearing 101 has 23 teeth and the second gearing 102 has 61 teeth. The angular distance between a gap in the first gearing and the nearest gap in the second gearing is plotted above the number of gaps in the first gearing 101. The numbering of the gaps is analogous to FIG. 4. The nominal angular position of the first gap of the first gearing 101 to the first gap of the second gearing 102 is equal to 0, wherein the first gap of the first gearing is the reference gap with respect to which the first gap of the second gearing is dimensioned and toleranced with an angular distance of 0. For the gap of the first gearing 101 with the index 0, the angular offset to the nearest gap of the second gearing 102 with the index 0 is therefore 0.

Since the number of teeth of the first gearing 101 and the second gearing are mutually prime, each gap of the first gearing 101 has an individual angular offset to the nearest gap of the second gearing. In other words, there is exactly one gap-to-gap angular offset, which is 0, namely for the reference gap of the first gearing 101 with the index 0.

FIG. 9 shows an example of the angular distances or angular offset, wherein the first gearing 101 has 24 teeth and the second gearing 102 has 62 teeth. The angular distance between a gap in the first gearing and the nearest gap in the second gearing is plotted above the number of gaps in the first gearing 101. The numbering of the gaps is analogous to FIG. 4. The nominal angular position of the first gap of the first gearing 101 to the first gap of the second gearing 102 is equal to 0, wherein the first gap of the first gearing is the reference gap with respect to which the first gap of the second gearing is dimensioned and toleranced with an angular distance of 0. For the gap of the first gearing 101 with the index 0, the angular offset to the nearest gap of the second gearing 102 with the index 0 is therefore 0.

Since the numbers of teeth of the first gearing 101 and the second gearing are not mutually prime, i.e. they have the same divisors, there is no individual angular offset for each gap of the first gearing 101 to the nearest gap of the second gearing, but there are repeating patterns. In other words, there are exactly two gap-to-gap angular offsets which are 0, namely for the gaps of the first gearing 101 with the index 0 and with the index 12. Each of these gaps of the first gearing 101 could therefore be used as a reference gap.

FIG. 10 shows an example of the angular distances or angular offset, wherein the first gearing 101 has 24 teeth and the second gearing 102 has 66 teeth. The angular distance between a gap in the first gearing and the nearest gap in the second gearing is plotted above the number of gaps in the first gearing 101. The numbering of the gaps is analogous to FIG. 4. The nominal angular position of the first gap of the first gearing 101 to the first gap of the second gearing 102 is equal to 0—whereby the first gap of the first gearing is the reference gap with respect to which the first gap of the second gearing is dimensioned and toleranced with an angular distance of 0. For the gap of the first gearing 101 with the index 0, the angular offset to the nearest gap of the second gearing 102 with the index 0 is therefore 0.

Since the numbers of teeth of the first gearing 101 and the second gearing are not mutually prime, i.e. have the same divisors, there is not an individual angular offset for each gap of the first gearing 101 to the respective nearest gap of the second gearing, but there are repeating patterns. In other words, there are exactly six times a gap-to-gap angular offset which is 0, namely for the gaps of the first gearing 101 with the indices 0, 4, 8, 12, 16, 20. Each of these gaps could therefore be used as a reference gap.

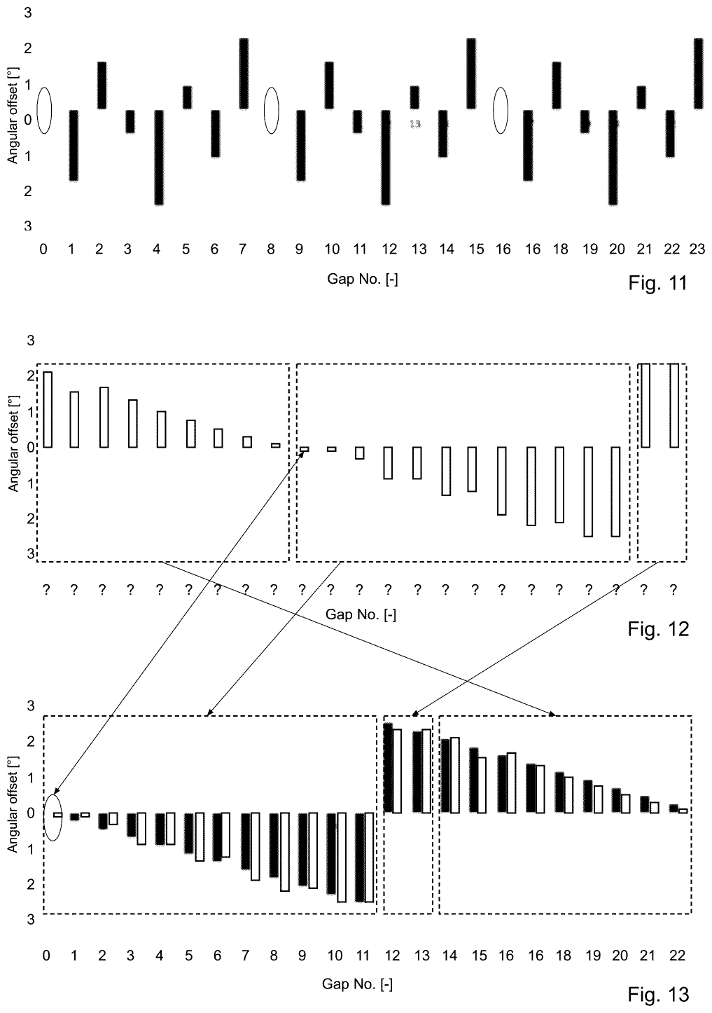

FIG. 11 shows an example of the angular distances or angular offset, wherein the first gearing 101 has 24 teeth and the second gearing 102 has 63 teeth. The angular distance between a gap in the first gearing and the nearest gap in the second gearing is plotted above the number of gaps in the first gearing 101. The numbering of the gaps is analogous to FIG. 4. The nominal angular position of the first gap of the first gearing 101 to the first gap of the second gearing 102 is equal to 0, wherein the first gap of the first gearing is the reference gap with respect to which the first gap of the second gearing is dimensioned and toleranced with an angular distance of 0. For the gap of the first gearing 101 with the index 0, the angular offset to the nearest gap of the second gearing 102 with the index 0 is therefore 0.

Since the numbers of teeth of the first gearing 101 and the second gearing are not mutually prime, i.e. they have the same divisors, there is no individual angular offset for each gap of the first gearing 101 in relation to the nearest gap of the second gearing, but there are repeating patterns. In other words, there are exactly three times a gap-to-gap angular offset which is 0, namely for the gaps of the first gearing 101 with the indices 0, 8, 16. Each of these gaps could therefore be used as a reference gap.

In the present examples, the first gap has been used as a reference in each case. This procedure was merely intended to provide a simple and clear illustration of the procedure according to the disclosure. However, it is clear that any other gap in the first gearing could be used as a reference in the same way.

Overall, a method according to the disclosure can therefore be specified, having the method steps of:
(A) providing a component 100, wherein the component 100 has a first gearing 101 and a second gearing 102, wherein a nominal angular position of the second gearing 102 relative to the first gearing 101 is defined for the component 101, and wherein the nominal angular position is specified as the nominal angular distance of a reference tooth R01 and/or a reference gap (0) of the first gearing 101 to a tooth R02 and/or a gap (0) of the second gearing 102;
(B) identifying the reference tooth R01 and/or the reference gap (0) of the first gearing 101, wherein the identification of the reference tooth R01 and/or the reference gap (0) of the first gearing 101 is carried out by assigning measured actual angular distances to predetermined nominal angular distances, wherein the nominal angular distances are predetermined angular distances of the teeth and/or gaps of the first gearing 101 relative to the teeth and/or gaps of the second gearing 102 corresponding to the predetermined nominal angular position and wherein the measured actual angular distances are the angular distances of the teeth and/or gaps of the first gearing 101 relative to the teeth and/or gaps of the second gearing 102 existing on the provided component 100 before the hard finishing of the second gearing 102;
(C) hard finishing of the second gearing 102 of the component 100, wherein the teeth of the second gearing 102 are machined taking into account the position of the reference tooth R01 and/or the reference gap (0) of the first gearing (101) in order to produce an actual angular position of the second gearing (102) relative to the first gearing (101) corresponding to the predetermined nominal angular position.

In the present case, the first gearing 101 of the provided component 100 has already been hard-finished before the second gearing 102 is hard-finished and before the reference tooth and/or the reference gap is identified. After the hard finishing of the first gearing 101 and before the hard finishing of the second gearing 102, the component 100 has been reclamped. The hard finishing of the first gearing 101 is carried out on a first machine tool and the hard finishing of the second gearing 102 is carried out on a second machine tool.

If a reference of the angular position is defined using a gap of the first gearing relative to a gap of the second gearing, this can be referred to as a reference gap pair.

If a reference for the angular position is defined using a tooth of the first gearing relative to a tooth of the second gearing, this can be referred to as a reference tooth pair.

1. A method including the following steps:
providing a component, wherein the component has a first gearing and a second gearing, wherein a nominal angular position of the second gearing relative to the first gearing is defined for the component, and wherein the nominal angular position is specified as the nominal angular distance of a reference tooth and/or a reference gap of the first gearing to a tooth and/or a gap of the second gearing,
identifying the reference tooth and/or the reference gap of the first gearing,
hard finishing the second gearing of the component, wherein the teeth of the second gearing are machined taking into account the position of the reference tooth and/or the reference gap of the first gearing in order to produce an actual angular position of the second gearing relative to the first gearing corresponding to the predetermined nominal angular position,
wherein
the identification of the reference tooth and/or the reference gap of the first gearing is carried out by assigning measured actual angular distances to predetermined nominal angular distances,
wherein the nominal angular distances are predetermined angular distances of the teeth and/or gaps of the first gearing relative to the teeth and/or gaps of the second gearing corresponding to the predetermined nominal angular position, and
wherein the measured actual angular distances are the angular distances of the teeth and/or gaps of the first gearing relative to the teeth and/or gaps of the second gearing existing on the provided component before the hard finishing of the second gearing.

2. The method according to claim 1,
wherein
the nominal angular distances of the teeth and/or gaps, are specified sorted consecutively in a clockwise or counterclockwise order so as to specify a nominal pattern of the nominal angular distances,
the actual angular distances of the nearest teeth are specified sorted consecutively in clockwise or counterclockwise order so as to specify an actual pattern of the actual angular distances,
wherein the identification of the reference tooth and/or the reference gap is carried out by a matching of the actual pattern with the nominal pattern.

3. The method according to claim 2,
wherein the matching of the actual pattern with the nominal pattern is carried out using a mathematical method.

4. The method according to claim 2,
wherein as a result of the assignment of the nominal angular distances to measured actual angular distances, the reference tooth is that tooth of the first gearing of the component whose actual angular distance corresponds to the nominal angular distance corresponding to the predetermined nominal angular position, wherein a matching of the nominal angular distance to the actual angular distance is carried out for one or more further teeth and/or gaps of the first gearing in order to verify the identification of the reference tooth and/or as a result of the assignment of the nominal angular distances to measured actual angular distances, the reference gap is that gap of the first gearing of the component whose actual angular distance corresponds to the nominal angular distance corresponding to the predetermined nominal angular position, wherein a matching of the nominal angular distance to the actual angular distance is carried out for one or more further teeth and/or gaps of the first gearing in order to verify the identification of the reference gap.

5. The method according to claim 1, wherein
the first gearing of the provided component has already been hard-finished before the hard finishing of the second gearing and before the identification of the reference tooth and/or the reference gap.

6. The method according to claim 5,
wherein after the hard finishing of the first gearing and before the hard finishing of the second gearing, the component is reclamped and/or
in that the hard finishing of the first gearing is carried out on a first machine tool and the hard finishing of the second gearing is carried out on a second machine tool.

7. The method according to claim 1, wherein the hard finishing of the first gearing is a scraping or a hard peeling or a honing and/or the hard finishing of the second gearing is a grinding.

8. The method according to claim 1,
wherein the first gearing has a smaller number of teeth than the second gearing and/or the first gearing has a smaller pitch circle diameter than the second gearing.

9. The method according to claim 1,
wherein the number of teeth of the first gearing and the number of teeth of the second gearing are mutually prime, wherein exactly one tooth and/or exactly one gap of the first gearing are defined as a reference tooth and/or as a reference gap.

10. The method according to claim 1,
wherein the number of teeth of the first gearing and the number of teeth of the second gearing have the same divisors, wherein a number of teeth suitable as reference teeth corresponds to the largest common divisor with respect to the number of teeth of the first gearing and the number of teeth of the second gearing, and wherein one of these teeth of the first gearing suitable as reference tooth is defined as reference tooth and/or
in that the number of teeth of the first gearing and the number of teeth of the second gearing have the same divisors, wherein a number of gaps suitable as reference gaps corresponds to the largest common divisor with respect to the number of teeth of the first gearing and the number of teeth of the second gearing, and wherein one of these gaps of the first gearing suitable as a reference gap is defined as a reference gap.
